(19) United States
(12) Patent Application Publication
(10) Pub. No.: US 2026/0254087 A1
(43) Pub. Date: Aug. 27, 2026

(54) CABLE APPARATUS AND METHOD

(71) Applicant: Samtec, Inc., New Albany, IN (US)

(72) Inventor: Troy B. Holland, New Albany, IN (US)

(21) Appl. No.: 18/992,532

(22) PCT Filed: Jul. 7, 2023
(86) PCT No.: PCT/US2023/027131

§ 371 Date: Jan. 8, 2025

Related U.S. Application Data
(60) Provisional application No. 63/359,397, filed on Jul. 8, 2022.

(51) Int. Cl. H01P 3/123; H01B 11/20; H01P 3/06; H01P 11/00; H01R 11/01

(52) U.S. Cl. CPC H01P 3/123; H01B 11/20; H01P 3/06; H01P 11/002; H01R 11/01

(57) ABSTRACT

A cable apparatus and method. A board connector and method. The cable assembly may include a cable. The cable assembly and/or the board connector may include one or more connectors and/or one or more conductors. The cable assembly may be a waveguide. The cable assembly, the board connector, or portions thereof, may be made by D3 printing or additive manufacturing, including multi-material 3D printing or additive manufacturing. Multi-material can include two or more of electrically non-conductive or insulative material, electrically conductive material, electrically lossy material, and magnetically absorbing material.

### CROSS-REFERENCE TO PREVIOUS APPLICATION

This application claims priority from U.S. provisional patent application no. 63/359,397 filed on Jul. 8, 2022, which is incorporated herein by reference in its entirety.

### TECHNICAL FIELD

The present embodiments relate generally to a cable apparatus/assembly, with particular embodiments shown for a waveguide.

### BACKGROUND

Typical waveguides are extruded thermoplastics and wrapped with metal tape. However, this practice often has a limited cross-sectional shape (e.g., oval, circular), prone to kink/collapse, hollow, large wall thickness, poor signal quality, and hard to metalize (e.g., wrap metal tape, and/or requires adhesive to wrap the metal tape). Thus, there is a need to improve customizability of a cable assembly such as, but is not limited to, waveguide structure (e.g., outer periphery, diameter, wall thickness, wall support, flexibility, etc.), metallization, mechanical support, manufacturing, and/or signal performance.

The present invention is directed at overcoming, or at least improving upon, the disadvantages of the prior art.

### SUMMARY

In some embodiments of the invention, for example, a cable assembly may include a cable and at least one first connector monolithically attached to a first end of the cable, wherein the cable and connector are both printed using a 3D printer.

In addition, in some embodiments, the cable assembly may include at least one second connector monolithically attached to a second end of the cable, wherein the second end of the cable is opposite the first end of the cable. In various embodiments, the cable may be a hollow waveguide. In some embodiments, the cable may include at least one electrical cable conductor. In some embodiments, the cable may include at least two electrical cable conductors. In various embodiments, at least one first connector may include a first vacuum port. In some embodiments, at least one second first connector may include a second vacuum port. In various embodiments, the cable may not be extruded. In some embodiments, at least one first connector may include no stamped electrical connector conductors. In various embodiments, the cable assembly may be printed within an area of approximately 50 mm cubed.

In some embodiments, a cable assembly may include a cable having opposing ends, wherein at least a portion of the cable is printed using a 3D printer.

In addition, in various embodiment, the cable assembly may include one or more connectors, wherein at least one connector may be attached to at least one end of the opposing ends. In some embodiments, the cable may include a non-conductive material and a conductive material surrounding at least a portion of the non-conductive material. In various embodiments, the cable may include one or more walls having one or more surface increasing structure. In some embodiments, the one or more surface increasing structure may be a wave. In various embodiments, the cable may include one or more support structures. In some embodiments, the one or more support structures may define one or more channels within the cable. In various embodiments, the cable may include a single channel therein. In some embodiments, at least one of the cable and/or at least one connector may include one or more vacuum ports. In various embodiments, the cable assembly may include one or more lenses. In some embodiments, the cable assembly may include at least one electrical conductor. In various embodiments, the cable assembly may include at least two electrical conductors. In some embodiments, at least a portion of at least one connector may be printed. In various embodiments, the cable and at least one connector are printed together. In some embodiments, at least one of a conductive material and a non-conductive material may be printed. In various embodiments, at least a portion of the cable may not be symmetric in cross-section. In various embodiments, the cable may be flexible between a first orientation to a second orientation different from the first orientation, and wherein the cable may be printed in the first orientation. In some embodiments, the cable may be a waveguide. In various embodiments, the cable may not be extruded. In various embodiments, the cable may include at least one connector on each one of the opposing ends of the cable.

In some embodiments, a method of 3D printing at least a portion of a cable assembly.

In some embodiments, a method to make a cable assembly comprising the step of simultaneously 3D printing the entire cable assembly during a single, pre-programmed, complete print cycle or process.

In various embodiments, a method to make a cable assembly comprising the step of attaching an electrically conductive contact or electrically conductive conductor to a respective flexible cable conductor without one or more of a solder, an IDC, and/or a friction connection. In some embodiments, the method may include plating the electrically conductive contact or conductor.

In some embodiments, a 3D printed cable assembly.

In various embodiments, a dielectric waveguide constructed from a photopolymer.

In some embodiments, a dielectric waveguide may include a waveguide body that defines an outer surface wherein (i) the outer surface further comprises a first surface and a second surface that intersects the first section, (ii) the first surface is approximately linear and (iii) the second surface is approximately non-linear. In various embodiments, the second surface may have a larger overall surface area than the first surface. In some embodiments, the second surface may define a repeating or recurring surface pattern. In various embodiments, the waveguide body may be hollow or at least partially hollow along a longitudinal length of at least a portion of the waveguide body.

In some embodiments, a dielectric waveguide may include a waveguide body that defines an outer surface wherein the outer surface has at least one second surface that takes a form of any one or more of sinusoidal, wavy, textured, rough, uneven, and/or unsmooth.

In addition, in various embodiments, the waveguide body may be solid in cross-section along a longitudinal length of at least a portion of the waveguide body. In some embodiments, the waveguide body may be hollow or at least partially hollow along a longitudinal length of at least a portion of the waveguide body.

In some embodiments, an article may include a first part and a second part physically connected to the first part, electrically connected to the first part or both, wherein the first part and the second part are both printed using a 3D printer.

In addition, in some embodiments, the first part and the second part may be both visually and structurally different from one another. In various embodiments, the first part may include a non-flexible, electrically dielectric housing. In some embodiment, the second part may be one or more of flexible, compliant, or bendable. In various embodiments, the first part may include at least one electrical contact or at least one electrical conductor. In some embodiments, the second part may include at least one waveguide, at least one electrically conductive cable conductor or both.

In some embodiments, a 3D printed electrical connector comprising a 3D printed electrically non-conductive housing and at least one 3D printed electrical contact or electrical conductor.

In some embodiments, a 3D printed electrical cable assembly comprising a 3D printed electrically non-conductive housing and at least one 3D printed flexible cable physically carried by the electrically non-conductive housing, electrically connected to at least one electrical contact carried by the 3D printed electrically non-conductive housing or both.

### BRIEF DESCRIPTION OF THE ILLUSTRATIONS

In the drawings, like reference characters generally refer to the same parts throughout the different views. Also, the drawings are not necessarily to scale, emphasis instead generally being placed upon illustrating the principles of the invention.

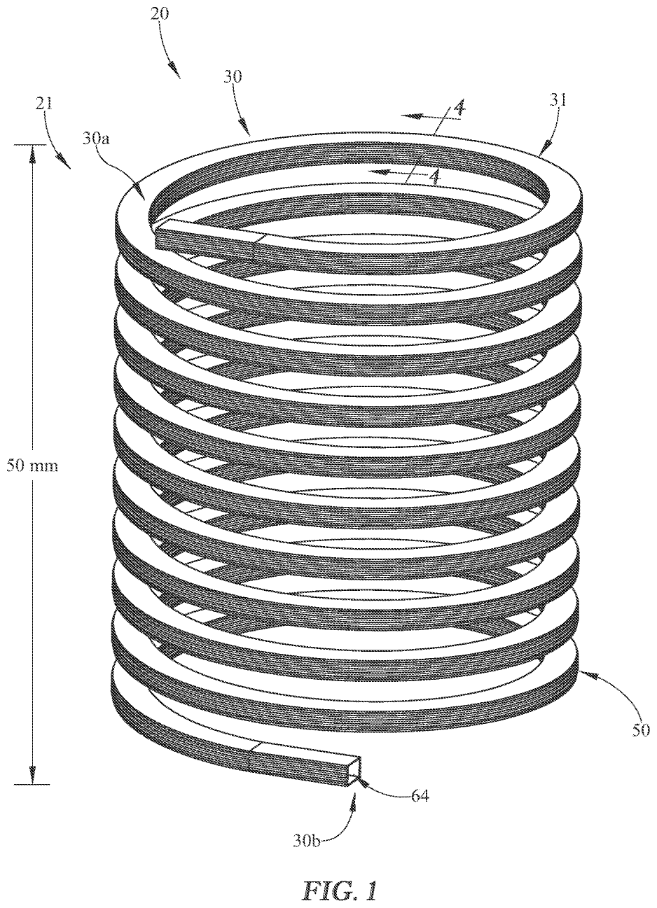

FIG. 1 is a perspective view of one embodiment of a cable assembly illustrating one embodiment of a cable.

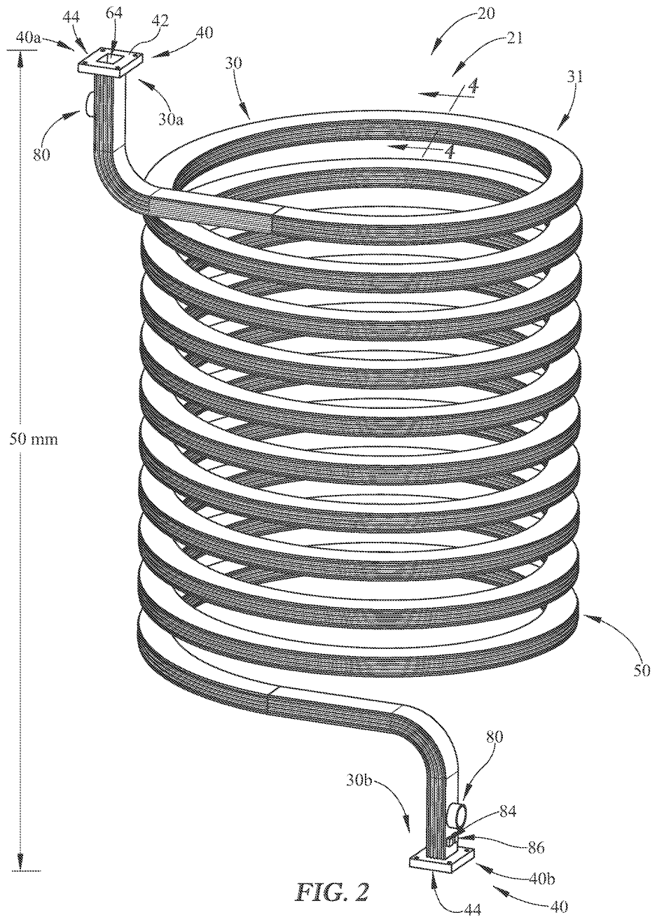

FIG. 2 is a perspective view of the cable assembly of FIG. 1 illustrating an embodiment of one or more connectors connected to the cable.

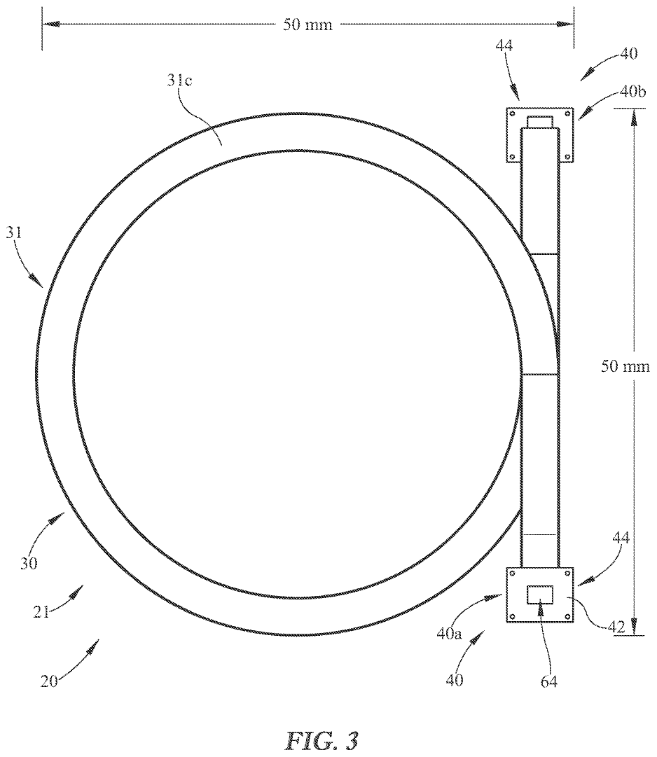

FIG. 3 is a top view of the cable assembly of FIG. 2

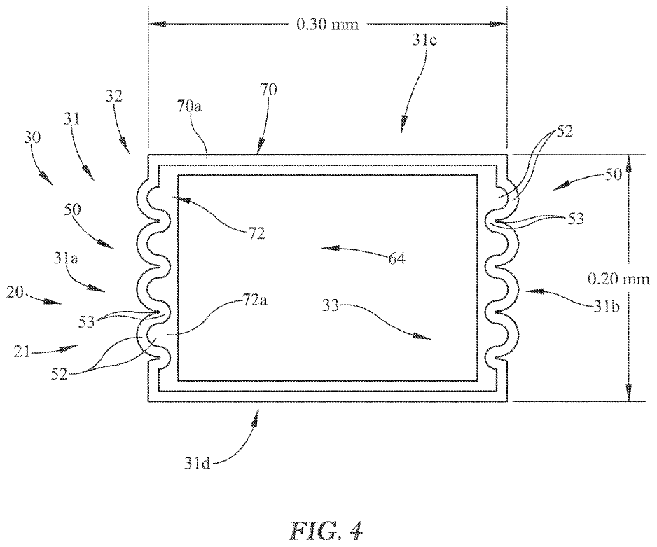

FIG. 4 is a sectional view taken along line 4 -4 of FIGS. 1 and 2 illustrating a hollow cable.

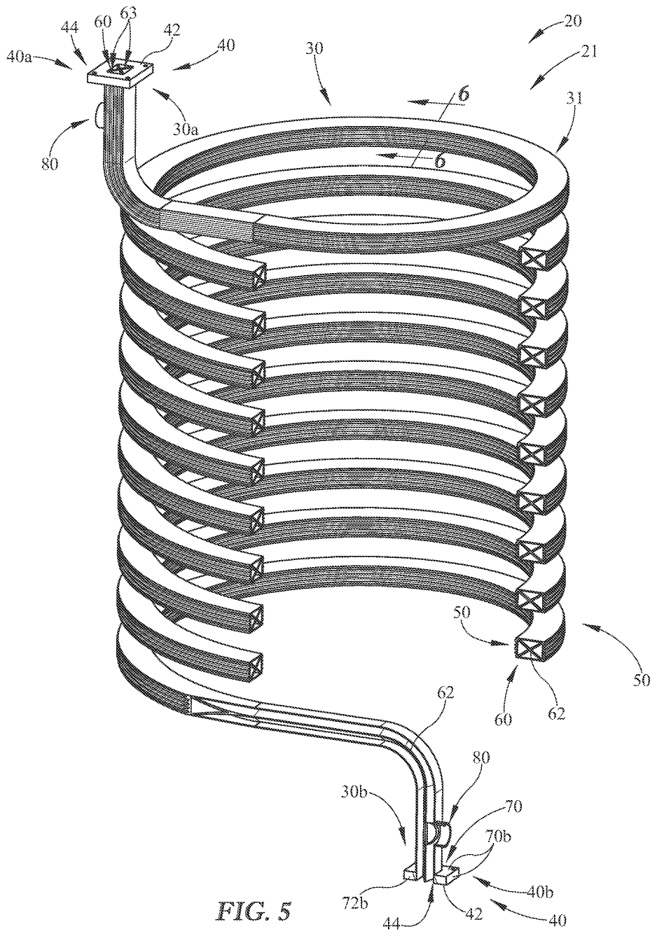

FIG. 5 is a perspective view of another embodiment of the cable and connector(s) of FIG. 2, with portions removed illustrating support structure defining channels therein.

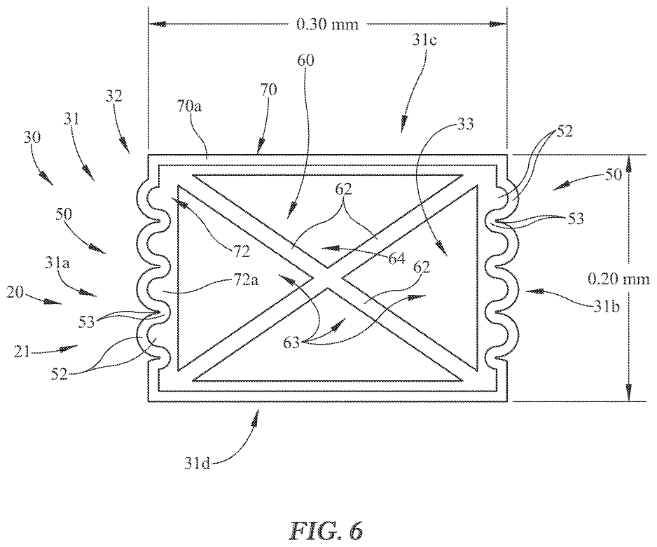

FIG. 6 is a sectional view taken along line 6 -6 of FIG. 5, illustrating support structure defining channels therein.

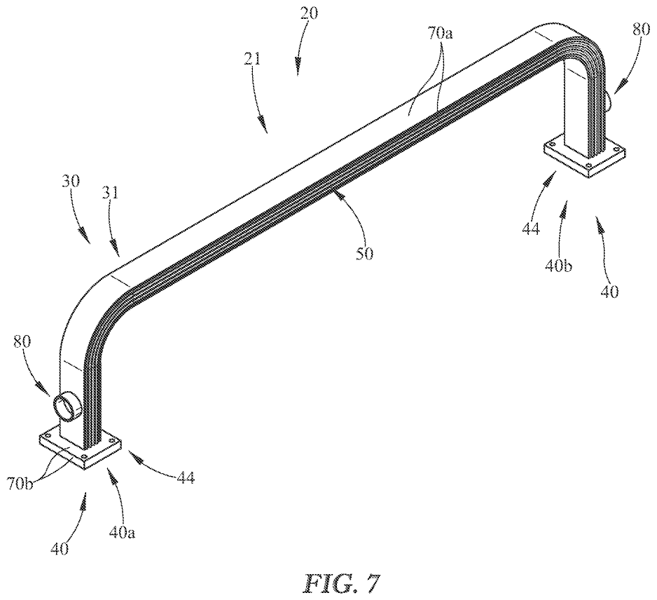

FIG. 7 is a perspective view of the cable assembly of FIG. 2 in another/different orientation/configuration.

FIG. 8 is an enlarged perspective view of the connectors of FIG. 2.

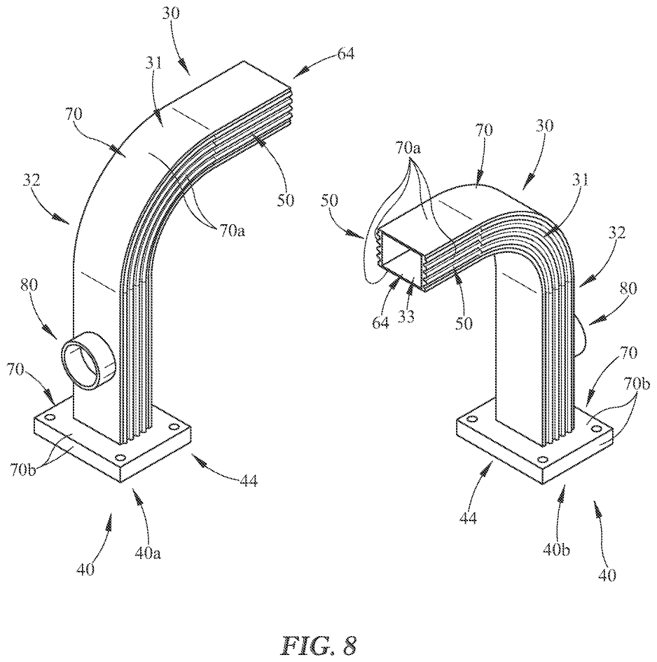

FIG. 9 is a perspective view of another embodiment of a cable assembly, illustrating one end of the two opposing ends of a coax cable assembly.

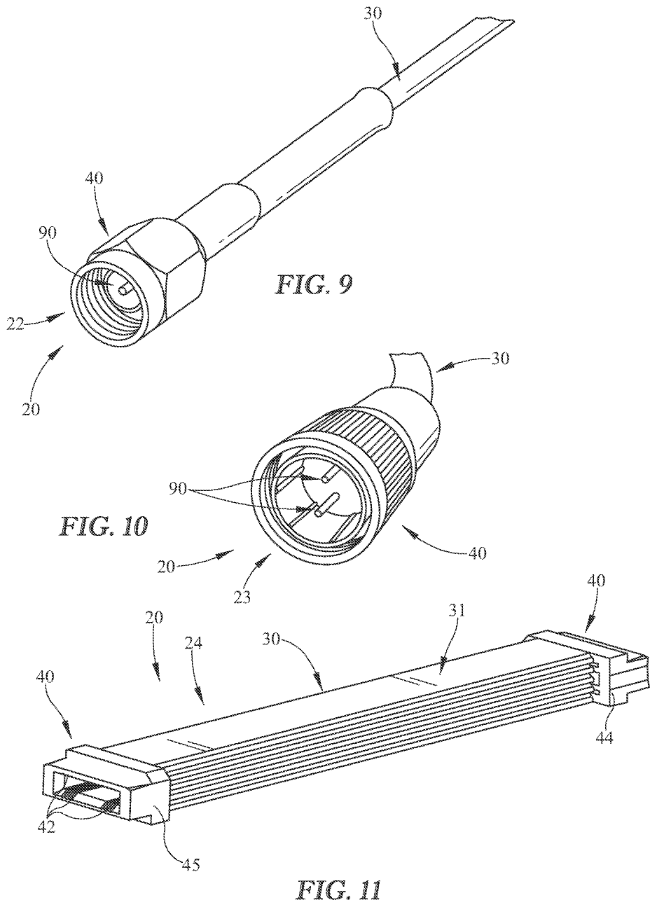

FIG. 10 is a perspective view of another embodiment of a cable assembly, illustrating a one end of the two opposing ends of a twin axial cable assembly.

FIG. 11 is a perspective view of another embodiment of a cable assembly, illustrating a non-waveguide cable assembly.

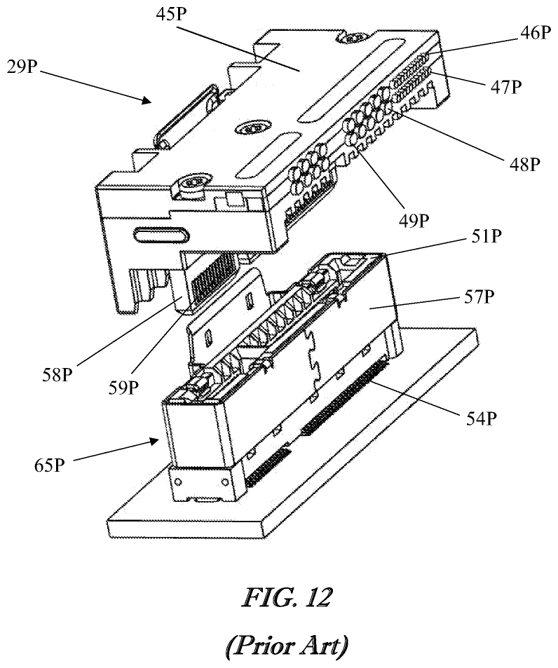

FIG. 12 is a perspective side view of a GC6 brand cable assembly, board connector and printed circuit board.

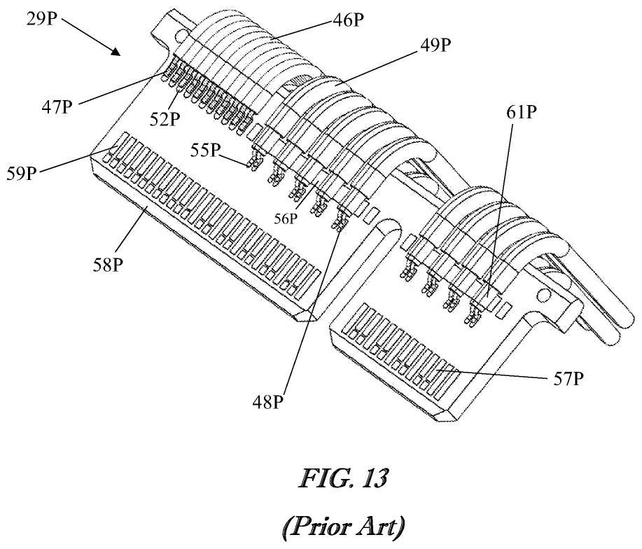

FIG. 13 is a perspective top view of the CG6 brand cable assembly shown in FIG. 12 with connector housings removed for clarity.

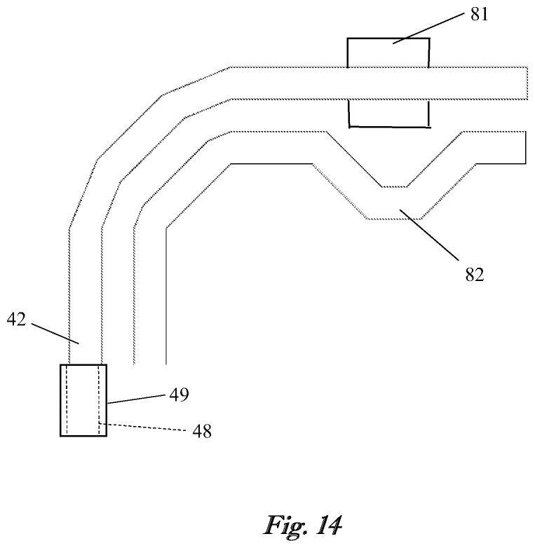

FIG. 14 is a top view of a differential signal pair that is devoid of cable attach mechanical or electrical discontinuities and with skew and/or impedance tuning.

### DETAILED DESCRIPTION

Embodiments may further be understood with reference to the various Figures. With reference to Figures, an embodiment provides for one or more cable assemblies 20 (e.g., waveguide 21, coaxial 22, twin axial, 23, non-waveguide 24). As shown in the embodiment in FIGS. 1-8, one example of the cable assembly 20 may be one or more waveguides 21 for electrical conductivity. The cable assembly 20 may include a body or housing, defined by one or more members. As shown in FIG. 1, the cable assembly 20 and/or waveguide 21 may include a cable 30. The one or more cables 30 may include an elongated body 31 having opposing ends, a first end 30a and a second end 30b. The cable 30 may be a variety of shapes, lengths, cross-sections, sizes, and constructions and still be within the scope of the invention. In some embodiments as shown in FIGS. 2, 3, 5, 7, and 8, the cable assembly 20 and/or cable 30 may include one or more connectors 40 (e.g., first connector 40a, second connector 40 b). The one or more connectors 40, if used, may be adjacent to or connected/attached to one or more ends (e.g., first end 30a and/or second end 30b). The one or more connectors 40 may be a variety of shapes, sizes, quantities, and constructions and still be within the scope of the invention. For example, although the connectors 40, if used, on opposing ends of the cable 30 are the same as shown in the one embodiment the connectors may be different in some embodiments. The one or more cable assemblies 20, or portions thereof, may electrically/physically connect two or more devices/structures (e.g., cable assemblies, modules, optics generator, etc.)

The one or more cable assemblies 20 (e.g., 21-24), or portions thereof, may be used in a variety of applications or devices. For example, the one or more applications/devices may include, but is not limited to, one or more module interconnects, optics generators, etc.

In some implementations, the cable assembly 20 (e.g., 21-24), waveguide 21, and/or cable 30 may include the elongated body 31. The body 31 may have an outer periphery 32 and an inner periphery 33. Although other cross-sectional shapes are contemplated, the outer and inner periphery 32, 33 may be generally rectangular in shape as shown in the one embodiment of FIGS. 4 and 6. One or more walls 31a-31d may define the outer and/or inner periphery 32, 33. The walls may be different and/or the same in shape as shown in the one embodiment relative to each other. In the one embodiment shown, the body 31 may include a pair of first opposing walls 31a and 31b interconnecting a pair of second opposing walls 31c and 31d. The first opposing walls 31a, 31b may be the same in some embodiments. The second opposing walls 31c, 31d may be the same in some embodiments. The first opposing walls may be different from the second opposing walls as shown in the one embodiment. The first opposing walls 31a, 31b (e.g., short axis/length) or outer periphery 32, or portions thereof, may define the electric current side(s). The second opposing walls 31c, 31d (e.g., long axis/length) or outer periphery, or portions thereof, may define the electrical field.

In some implementations, the cable and/or one or more walls/surfaces defining the inner and/or outer peripheries 33, 32 (e.g., first opposing walls 31a and 31b) may include surface or surface area increasing structure 50. The outer surface or periphery may include a first linear surface and a second non-linear surface. The second surface may have a larger overall surface area than the first surface. The second surface may include a repeating or recurring surface pattern. As shown in the one embodiment of the figures, the outer periphery 32 and/or wall(s) (e.g., first opposing walls 31a, 31b, short axis/length) may include the one or more surface increasing structures 50. One embodiment of the surface increasing structure 50 (e.g., second surface), if used, may include at least one wall/surface of the first opposing walls 31a, 31b (e.g., outer periphery) having one or more waves/pleats/ribs/fins 52 and/or be sinusoidal/textured/rough/uneven/unsmooth (e.g. defining channels 53 therebetween). Further, one or more walls and/or first opposing walls 31a, 31b may have an increased cross-sectional area, as compared to one or more walls and/or second opposing walls 31c, 31d. The surface increasing structure 50 and/or increased cross-sectional area may increase conductivity, increase dissipation of heat, and/or allow for higher current densities to be achieved for a given amount of resistance and/or heat rise. In the one embodiment shown in the figures, the inner periphery 33, surface(s), or wall(s) (e.g., first opposing walls, second opposing walls), or portions thereof, may be substantially planar as shown in the one embodiment. Although not shown, the inner periphery, or portions thereof, may include one or more surface increasing structures.

In some implementations, the cable assembly 20 (e.g., 21-24), or portions thereof, (e.g., body, connector, cable) may be defined by one or more members/pieces. As shown in the one embodiment of the Figures, the cable assembly 20, cable 30, and/or body 31 may include a single member. Although the cable 30 or body 31 is shown as a single member in FIG. 1, it should be understood that the cable may be a plurality of members defining one or more lengths/circumferences in some embodiments.

The inner periphery and/or outer periphery may be a variety of shapes, sizes, quantities, and constructions and still be within the scope of the invention. For example, the cross section of the body is shown as the same for the entire length of the cable, however the cross-section (e.g., inner periphery, outer periphery, wall(s), and/or surface increasing structure) may change/vary along the length. The cable and/or body may not be symmetric as shown in the one embodiment, however it should be understood that the cable/body may be symmetric in some embodiments.

In some implementations, the cable assembly 20 (e.g., 21-24), waveguide 21, cable 30, and/or body 31 may include/define one or more support structures/lattice/webs 60. The one or more support structures 60, if used, may be one or more members 62 providing mechanical support or strengthen the cable or body. This support structure(s) may reduce collapsing/kinking of the cable in some embodiments. As shown in the one embodiment in FIGS. 5 and 6, the support structures 60 or members 62 may be positioned within the inner periphery 33 or body 31 of the cable 30. The support structures 60 may connect one or more walls/surfaces 31a-31d of the inner periphery 33. The support structures/members may define one or more elongated channels 63 within the inner periphery, cable, and/or body. The support structure, if used, may extend for one or more lengths or portions of the cable or body. The support structure and/or channels may be a variety of shapes, sizes, quantities, positions, and constructions and still be within the scope of the invention.

In some implementations, the cable assembly 20, waveguide 21, cable 30, and/or body 31 may include/define a hollow interior and/or lack support structure 60 (e.g., protrusions, members). As shown in the one embodiment in FIGS. 1-4 and 7-8, the waveguide 21, cable 30, and/or body 31 is hollow and/or includes a single channel 64 therethrough. The inner periphery, walls, or surfaces (e.g., planar, curved) may not define one or more support structures and/or provide a hollow portion or single channel for one or more lengths of the cable or body.

In some implementations, the cable assembly 20 (e.g., 21-24), waveguide 21, cable 30, and/or body 31 may include the one or more connectors 40. The one or more connectors 40 may be included/attached on one or more ends 30a, 30b of the cable/body. The connector 40, if used, may electrically/physically connect the cable/body, or portions thereof, to one or more devices. In the embodiments shown in FIGS. 2, 3, 5, and 9-11, the one or more connectors 40 may include one or more contacts or electrical conductors 42 and/or mechanical fasteners 44. The mechanical fastener 44, if used, may be a flange with one or more mounting through holes as shown in the one embodiment in FIGS. 2, 3, 5, 7, and 8. The contacts or electrical conductor(s) 42 may be positioned on one or more surfaces (e.g. flange, mechanical fastener) of the one or more connectors 40. In some embodiments, the connector 40 may not include a stamped electrical connector conductor or contact. Alternatively, in various embodiments, the contacts may be stamped. The one or more connectors 40, or portions thereof, may be integrally or monolithically formed (e.g. printed) with the cable and/or body in some embodiments as shown in FIGS. 2, 3, 5, 7 and 8. Alternatively, in some embodiments, the one or more connectors 40 may be made separately (e.g. printed, molded, etc.) and subsequently assembled to the cable 30 and/or body 31.

In some implementations, the cable assembly 20 (e.g., 21-24), waveguide 21, cable 30, body 31, and/or connector(s) 40, or portions thereof, may include one or more electrically conductive materials 70 and/or non-conductive materials 72. As shown in the one embodiment, the cable 30 and/or connector(s) 40 may include one or more conductive materials 70 and non-conductive materials 72. The one or more conductive materials 70 may include one or more first conductive materials 70a and/or second conductive materials 70b. The one or more non-conductive materials 72 may include one or more first non-conductive materials 72a and/or second non-conductive materials 72b. In some embodiments as shown more clearly in FIGS. 4 and 6, the one or more first conductive materials 70a, if used, may surround/cover or be disposed over the first non-conductive materials 72a (e.g., the outer periphery or circumference (e.g. 360 degrees)) of the cable 30 and/or extend the length, or portions thereof, of the cable. In some embodiments, the one or more second conductive materials 70b, if used, may surround/cover or be disposed over one or more second non-conductive materials 72b (e.g., outer periphery) of the connector(s) 40. The first and second conductive materials 70a, 70b may be in electrical/physical connection with each other. The first and second non-conductive materials 72a, 72b may be in physical connection with each other. The first and second conductive materials 70a, 70b may be in electrical connection with the one or more contacts or electrical conductors 42 of the one or more connectors 40. The first and second conductive materials 70a, 70b may be integrally made (e.g., printed) with each other or separately made in some embodiments. The first and second conductive materials 70a, 70b may be integrally made (e.g., printed) with the contacts or electrical conductors 42 or separately made in some embodiments. The first and second non-conductive materials 72a, 72b may be integrally made (e.g., printed) with each other or separately made in some embodiments.

In some implementations, the cable assembly 20, waveguide 21, cable 30, and/or connector(s) 40 may include one or more vacuum ports 80. The vacuum ports 80, if used, may be in fluid communication with one or more external vacuum sources (not shown). In the embodiment shown, each of the opposing ends 30a, 30b of the cable 30/assembly 20 and/or connector 40 includes the vacuum port 80. It should be understood that only one end may include a vacuum port in some embodiments. For example, when two or more cables or cable assemblies are connected to each other in series. In the one embodiment shown, a wall or second opposing wall 31c, 31d may include the one or more vacuum ports 80. The one or more vacuum ports 80 may be in fluid communication with each other through one or more channels 63, 64 defined by the inner periphery 33 and/or support structure 60 of the cable 30/connector(s) 40. The vacuum source/port may provide a vacuum through the cable/assembly/connector (e.g., channel(s)) to lower the overall dielectric constant of the structure.

In some implementations, as shown in the one embodiment in FIG. 2, the cable assembly 20, waveguide 21, cable 30, and/or connector(s) 40 may include one or more lenses 84 and/or adjustment mechanism 86. The adjustment mechanism 86, if used, may adjust the optical and/or light characteristics of the lens 84, if used.

In some implementations, the cable assembly 20 (e.g., 21-24), waveguide 21, cable 30, non-conductive materials 72, and/or electrically conductive material(s) or conductors 70, 42, or portions thereof, may be made by additive manufacturing. For example, in some embodiments, the cable 30 (e.g., body), connector(s) 40, non-conductive materials 72, and/or the one or more electrically conductive materials 70, or portions thereof, may be printed (e.g., 3D) with one or more materials. One such process may be, but is not limited to, vat polymerization, material jetting, and/or binder jetting. In the one embodiment shown in FIGS. 2-11, both the cable 30 and connectors 40 (e.g., the one or more electrically conductive materials or conductors 70a, 70b, and/or 42 and non-conductive materials 72a, 72b) may be printed together. For example, the nonconductive/dielectric material 72 (e.g., resin, glass-fiber infused 3D printing material) and/or conductive material 70 (e.g., metal) may be printed together to form the cable assembly (e.g., connector and cable). In another embodiment shown in FIGS. 1-11, the cable 30, or portions thereof, (e.g., the one or more electrically conductive materials 70a and/or non-conductive materials 72a) may be printed (e.g., 3D). For example, the nonconductive/dielectric material 72 (e.g., resin) and/or conductive material 70 (e.g., metal) may be printed together to form the cable assembly (e.g., cable). In another embodiment, a first printing structure (e.g., a cable with both non-conductive materials and one or more electrically conductive materials) may be printed and assembled/attached with at least one second printing structure (e.g., one or more connectors with both non-conductive materials and one or more electrically conductive materials) printed separately from the first printing structure. In various embodiments, the non-conductive material 72a, 72b of both cable and/or connector(s) may be printed in first printing and the one or more electrically conductive materials 70a, 70b may be printed in a second printing in series or after the first printing. For example, the non-conductive material of the cable with or without the connectors may be printed (e.g., first printing) then the conductive material(s) may be printed (e.g., second printing) directly over the printed cable/connector(s) first printing. Further, in some embodiments, either one of the cable or connector(s) may be printed in the non-conductive material with or without the electrically conductive material and the other of the cable or connector may not be printed. For example, the cable may be printed with both the electrically conductive material and non-conductive material then one or more connectors (e.g., not printed) may be attached to the cable.

In some implementations, it should be understood that the electrically conductive contacts or electrical conductors 42, if used, may or may not be printed with the connector/cable in the herein described examples. If the conductive plates are not printed with the connector/cable, the conductive plates may be subsequently attached to the connector(s) (e.g., printed and attached, printed over a portion of the connector, stamped).

In some implementations, the non-conductive material of the cable assembly (e.g., 21-24), or portions thereof, (e.g., cable and/or connector) are printed and then metalized/plated with one or more coatings/layers (e.g., conductive material(s)). For example, the non-conductive materials 30 of the cable and/or connector(s) 40 may be printed and subsequently plated with one or more layers such as, but is not limited to, an electroless layer followed by electroplating of one or more materials (e.g., metals and/or alloys). The conductive contact or electrically conductive conductor may be attached to the non-conductive material or flexible cable 30 without one or more of solder, an IDC, and/or a friction connection. If the non-conductive material of the connector(s) and cable are printed separately, the connector and cable may be coated with the conductive material separately then combined or combined then coated with the conductive material. A low surface roughness of the plating and/or printed electrically conductive material, as compared to metal tape, may allow for improved mechanical and/or signal performance.

A variety of printers may be used and still be within the scope of the invention. In some applications the cable and/or connectors, or portions thereof, may be printed using one or more of a high resolution digital light projection (DLP) photopolymer printer, such as a Boston Microfabrication (BMF) S230 brand printer with a 2 um resolution, an inkjet printer, such as the NANODIMENSION DRAGONFLY-brand printer, commercially available from NANODIMENSION, Ness Ziona, Israel, aerosol jet printer, an atomic layer deposition (ALD) printer, a fused deposition (FDM) printer, a fused filament fabrication printer, and a syringe/slurry dispenser or printer. An example of a printer that combines multiple printing techniques is an NSCRYPT 3DN-300 brand printer, commercially available from NSCRYPT, Inc., Orlando, FL.

In some implementations, the cable assembly 20 (e.g., 21-24), cable 30, connector 40, or portions thereof, may be made of a variety of materials. The cable and/or connector, or portions thereof, may be made from one or more materials (e.g. electrically non-conductive, electrically conductive, metals (e.g. conductive or metallic), thermally conductive, thermally non-conductive, printed, non-printed, electrically lossy, magnetic absorbing, electrically lossy material tuned to within 5GHz of a resonance frequency, a magnetic absorbing material tuned to with 5GHz of a resonance frequency, etc.). Electrically conductive materials can include, but are not limited to, conductive polymers, superconducting or superconductive materials, niobium, niobium titanium, yttrium-barium-copper-oxide, indium tin oxide, silver, copper, nickel, metal oxides, metallic ink(s), etc. may be used in some applications of the electrically conductive material 70. Electrically lossy materials typically have a conductivity of about 1 siemens/meter to about 6.1×107 siemens/meter, preferably about 1 siemens/meter to about 1×107 siemens/meter and most preferably about 1 siemens/meter to about 30,000 siemens/meter. Electrically lossy materials may be partially conductive materials, such as those that have a surface resistivity between 1 Ω/square and 106 Ω/square. In some embodiments, the electrically lossy material has a surface resistivity between 1 Ω/square and 103 Ω/square. In some embodiments, the electrically lossy material has a surface resistivity between 10 Ω/square and 100 Ω/square. As a specific example, the material may have a surface resistivity of between about 20 Ω/square and 40 Ω/square.

The electrically non-conductive or dielectric materials 72, or portions thereof, may be a ceramic or plastic or polymer-based material/resin (e.g. thermoset, LOCTITE 406, UV curable thermoplastic, photopolymer, thermopolymer) used in some applications of the assembly. In some implementations, the one or more cable assemblies 20 (e.g., 21-24), cable 30, and/or connector(s) 40 may be printed in a variety of orientations/positions/configurations within a variety of build volumes. The assembly may be printed in a first orientation/position/configuration as shown in FIGS. 1-3. As shown in the one embodiment in FIGS. 1, 2, and 5, the elongated structure of the assembly 20 (e.g., cable and/or connector(s)), or portions thereof, may be printed in current DLP printer volumes, such as the 50 mm by 50 mm-by-50 mm XYZ build volume (e.g. 50 mm cubed). Because the cross-section of the assembly (e.g., cable) may be reduced and/or flexible, the cable 30 may be wound/spiraled/overlapped within the build volume (e.g., first orientation). The connector, if used/printed with the cable, may be positioned relative to the spiraled position of the cable (e.g., inside and/or outside(shown)). The connector, or other portion, may be non-flexible in some embodiments. The assembly, or portions thereof, (e.g., cable) may subsequently be flexed or reconfigured to at least one another or second orientation(s)/position(s)/configuration(s) (e.g., different from the printed first orientation) as shown in FIG. 7 for one or more applications. In some embodiments, the assembly, or portions thereof, may printed and used in the same orientation. For example, the orientation of the assembly 20 in FIG. 7 may be both the first orientation and the second orientation in some embodiments. The connector may be both visually and structurally different from the cable in some embodiments.

In some implementations, the cable assembly 20 may be devices other than the waveguide 21. For example, a non-waveguide cable assembly 20 may be a coaxial cable assembly 22 or twin axial cable assembly 23. As shown in FIG. 9, the coaxial cable assembly 22 may include at least one electrical cable conductor 90, cable 30, and/or connector(s) 40. For example, the coaxial cable assembly 22 may include at least one electrical cable conductor 90 extending through the cable 30 and connectors 40 at opposing ends 30a, 30b. Further, for example, the twin axial cable assembly 23 may include at least two electrical cable conductors 90. As shown in FIG. 10, the twin axial cable assembly 23 may include at least two electrical cable conductors 90, cable 30, and/or connector(s) 40. The coaxial or twin axial cable assemblies 22, 23 (e.g., shield, electrical cable conductors 90, connector contacts, jacket, dielectric material(s), conductive material(s), etc.), or portions thereof, may be printed, in a printing process (e.g., 3D printing), complete with coaxial or twin axial cables, electrical connector conductors, etc. In some embodiments, the coaxial or twin axial or waveguide or flex circuit cable assemblies 22, 23 may include printed and non-printed portions thereof. 3D printing a complete cable assembly (e.g. coaxial cable assembly, twin axial cable assembly, non-waveguide assembly, waveguide assembly, flex circuit cable assembly) may not include the steps of stamping and forming electrical connector contacts, over molding the electrical connector contacts, extruding coaxial or twin axial cable conductors with a polymer, wrapping the cable with a shield, and/or terminating the cable conductors to the electrical connector contacts, etc.

Another embodiment of a non-waveguide assembly 24 embodiment of the electrical cable assembly 20 is shown in FIG. 11. One or more portions of the assembly 24 may be printed. For example, the printer (e.g., 3D) may print the metal and/or dielectric materials of the cable 30 and/or connectors 40 (e.g., both ends, one end), and then the mating ends or contacts or electrical conductors 42 of the electrical cable conductors 90 can be plated in a separate step. Alternatively, the contacts or electrical conductors 42 may be printed with the remaining portions of the assembly in some embodiments.

A method can include the step of providing any one of a visual depiction, an image, a model, an engineering model, a solid model, a 3D model, an encrypted model, a SOLIDWORKS model, etc. that represents any one of a group selected from a three-dimensional, multi-material electrical connector or a three-dimensional, multi-material electrical cable assembly. Another step can include tuning or improving single-ended or differential impedance by eliminating, in the visual depiction, the image, the model, the engineering model, the solid model, the 3D model, the encrypted model, the SOLIDWORKS model, etc., solder or weld or insulation displacement or epoxy or conductive epoxy or crimp attachments between one or more of cables or waveguides and one or more corresponding electrical conductors, electrical pads, or electrical traces. Another step can include printing a three-dimensional, multi-material electrical connector or three-dimensional, multi-material electrical cable assembly according to or that looks like the visual depiction, the image, the model, the engineering model, the solid model, the 3D model, the encrypted model, the SOLIDWORKS model, etc. during a single print process or single print period or single print operation. Another step can include plating portions of the three-dimensional, multi-material electrical connector or the three-dimensional, multi-material electrical cable assembly after the step of printing the three-dimensional, multi-material electrical connector or the three-dimensional, multi-material electrical cable assembly during the single print process or the single print period or the single print operation.

Multi-material can include at least two different materials, such as an electrically conductive material for some portions and an electrically non-conductive material for other portions, a thermally conductive material for some portions and a thermally insulative material for other portions, etc., or any possible combination thereof. A single print process or period or operation can mean a period of time starting when a printer starts to print a multi-material object to a future time when the multi-material object is completely printed. A single print process or period or operation can mean a period of time from when a printer or a group of printers creates an object that substantially includes all of the features of an underlying model. A single print process or period or operation can mean a period of time that starts when a printer is instructed to print and ends when the instructed print job is complete. A single print process/period/operation can be done with a single printer. A single print process/period/operation can be done with a single printer that has at least two different print heads, each respectfully connected to two separated storage containers that each contain materials that are different from one another in electrical conductivity, thermal conductivity, dielectric constant, etc.. A single print process/period/operation can be done with a single print head attached to two separate material storage containers that each contain material that are different from one another. A single print process or period or operation can be done with means for delivering two materials that are each different from one another. A single print process/period/operation can be done with two different printers working to create a common three-dimensional printed object. A single print process or period or operation does not have to be continuous. Intermediate breaks can be taken within a single print process or period or operation to cure materials, switch or exchange or position print heads, replenish material storage containers, move an object from one printer to another printer, etc.

A method can include the step of creating or printing a three-dimensional electrical interconnect, complete with electrical conductors and an insulative housing, during a single print process or a single print period or single print operation. Another method can include the step of creating or printing a finished three-dimensional, electrical interconnect, complete with electrical conductors, an insulative housing, and electrical conductor plating during a single print process or a single print period or single print operation. For example, a printer or printers can fabricate, or duplicate three-dimensional, electrical conductors made from electrically conductive metals like copper, silver, aluminum, etc. or electrically conductive alloys and then deposit a noble metal on the electrical conductors, such as one or more of mating, mounting and intermediate portions of the electrical conductors.

An apparatus can include a cable assembly 20, 21 shown above, including the cable assemblies 22, 23, 24 shown in FIGS. 9-11. As a non-limiting example, FIG. 11 shows a cable assembly 24 that can include a dielectric or an electrically insulative housing 45, contacts or electrical conductors 42, and at least one of a coaxial or twin axial or waveguides or flex cables 30. Together, the electrically insulative housing 45 and the contacts or electrical conductors 42 can form an electrical connector. Contacts or electrical conductors 42 can include plating, shielding or both. Plating, such as at one or more of mating ends, mounting ends, and/or intermediate portions of contacts or electrical conductors 42 or on electrical pads, can be printed in situ with the rest of the cable assembly 20, with the contacts or electrical contacts 42, and cables 30. Cables 30 can each include at least one, at least two electrical, at least three, or three or more electrical cable conductors 90 (FIGS. 9 and 10), respectfully. Electrical cable conductors 90 (FIGS. 9 and 10) can be flex cable conductors. As shown in FIGS. 9 and 11, electrical cable conductors 90 can form a portion of a RF or coaxial transmission line. As shown in FIG. 10 and 11, physically, immediately adjacent electrical cable conductors 90 can form a portion of a twin axial transmission line.

Cable assemblies 22, 23, 24 can each include a dielectric or electrically insulative housing, such as electrically insulative housing 45 shown in FIG. 11. A plurality of traces or pads or contacts or electrical conductors 42 can be carried by the electrically insulative housing 45 or a printed circuit board carried by the electrically insulative housing 45. A plurality of electrical cable conductors 90 (FIGS. 9 and 10) can each be electrically connected to a corresponding one of the plurality of traces or pads or contact or electrical conductors 42. At least 25%, at least 50%, at least 75% and 100% of the electrical cable conductors 90 (FIGS. 9 and 10) can be not mechanically attached to their corresponding trace or pad or contact or electrical conductor 42 (FIG. 11).

The Applicant helps solve a first long-felt need in the industry, namely reducing the number of steps or manufacturing time or cost necessary to make a complex, multi-component object, such as electrical cable assembly, without reducing or eliminating the electrical performance of the object. As one example, present invention reduces the number of processing steps to no more than one, no more than two or no more than three print cycles or print operations or print periods. An entire electrical cable assembly or board connector can be printed in situ, using no more than one or two printers. Conductor stamping, housing moldings, cable extrusion and wrapping, cable attach, and even contact or electrical conductor plating can all be done with one or two multi-material, three-dimensional printers. As another example of solving a long-felt need, solder joints or solder cable attach, which are prone to cracking, shorting, and electrical opens, can be eliminated in an electrical cable assembly.

An unexpected result of the present invention is that 3D printing reduces electrical discontinuities along an overall or entire electrical length, physical length or both of a single-ended transmission line carried by an electrical cable assembly. An unexpected result of the present invention is that 3D printing reduces electrical discontinuities along an overall or entire electrical length, physical length or both of a differential signal transmission line carried by an electrical cable assembly. Without being bound by theory, by eliminating a need for mechanical component attachment, such as soldering two components together, fastening two components together, welding two components together, gluing or epoxying two components together, etc., single-ended or differential impedance can be tightly controlled, insertion loss can be reduced, unwanted resonances can be mitigated, and unwanted crosstalk can be reduced.

Reducing the number of steps or manufacturing time or cost necessary to make a complex, multi-component object can be illustrated, at a high level, by comparing the instant disclosure of the Applicant to a random cable assembly, commercially available from SAMTEC, Inc. A randomly identified, finished electrical cable assembly that is offered for sale by the Applicant in the year 2023 currently requires more than ten discrete manufacturing steps, more than three discrete component shipments for intermediate step processing, and more than four separate pieces of manufacturing equipment to produce one finished cable assembly. In contradistinction, embodiments disclosed herein reduce the discrete manufacturing steps to one print cycle or one print operation or one print period, no discrete component shipments for intermediate step processing, and no more than one or two three-dimensional or additive manufacturing printers.

An example of reducing or eliminating solder joints or solder cable attachments can be shown with the help of FIGS. 12 and 13. FIG. 12 shows a GC6-Series cable assembly 29P and a corresponding, mating board connector 65P, both commercially available from Samtec, Inc. in the year 2023. Electrically insulated housing 45P of the cable assembly 29P is formed in two parts that are held together by three fasteners. Single-ended or coaxial or RF cables 46P each carry a corresponding single-ended or coaxial or RF cable conductor 47P. Twin axial cables 49P each carry at least one or two twin axial cable conductors 48P. Each GC6-Series cable assembly 29P can further include a two-part electrically insulated housing 45P, three fasteners, and a latch. Electrically insulative board connector housing 51P carries at least eighty-four stamped, formed, and gold-plated electrical board conductors 54P. A shield 57P is shown. Stamping, forming and plating take, at a minimum of three manufacturing or processing steps. Using the disclosure provided in this patent application, at least the stamping step can be eliminated, resulting in a percent decrease of 33% and a 40% percent difference.

Returning to the GC6-Series cable assembly 29P shown in FIG. 13, each corresponding single-ended or coaxial or RF cable conductor 47P can be soldered to a corresponding, respective first printed circuit board mounting pad 52P carried by a printed circuit board 58P. Twin axial cables 49P each carry at least one or a pair of corresponding twin axial cable conductors 48P that are soldered to a corresponding, respective second PCB mounting pad 55P carried by printed circuit board 58P. Printed circuit board mating pads 59P are plated in gold and are each electrically connected to a corresponding first printed circuit board mounting pad 52P or a corresponding second printed circuit board mounting pad 55P. Cable ground shields, such as exposed cable ground shields 61P, are each soldered to a corresponding printed circuit board ground pad 56P.

The construction of the GC6-Series cable assembly 29P shown in FIGS. 12 and 13 therefore requires many solder joints and more than, more than three, more than four and more than five discrete soldering processing steps. For example, as shown in FIG. 13, there are up to twenty-two discrete single-ended or coaxial or RF cable solder joints, up to thirty-six discrete twin-axial or differential solder joints, up to eighteen solder joints between respective cable ground shields of each twin axial cable 49P and a corresponding printed circuit board ground pad 56P. There are, conservatively, between fifty and seventy-six separate solder joints in the GC6-Series cable assembly 30P shown in FIGS. 12 and 13. Using the disclosure provided in this patent application, all or all but one or all but two or all but three or all but four of the discrete solder joints can be eliminated, satisfying a long-felt need to reduce solder joints. Solder joints historically add, individually or in any combination, solder joint expense, solder joint failure, solder joint cracking, electrical shorting between two immediately adjacent solder joints, electrical opens between a cable conductor and a respective mounting pad, more manufacturing steps and manufacturing time needed to make a cable assembly or a board connector. A reduction of mechanical solder joints from seventy-six to zero represents a 100% decrease. A percent difference between seventy-six and one (division by zero is not possible) is approximately 195%.

According to the disclosure provided in this detailed description, the GC6-Series cable assembly 29P shown in FIGS. 12 and 13 can be manufactured in no more than one print operation or no more than two print operations, using a single, multi-material printer. The GC6-Series board connector 65P can be manufactured in no more than one print operation or period or cycle, or no more than two print periods or operations or cycles, using a single, multi-material printer. A method can include the step of reducing several processing steps needed to create a finished cable assembly by at least one of at least 10%, at least 20%, at least 30%, at least 33%, at least 40%, at least 50%, at least 60%, at least 70%, at least 80%, at least 90% and at least 95% compared to soldering or otherwise discretely attaching individual cable conductors to corresponding, discrete printed circuit board mounting pads or to corresponding discrete contact or electrical conductor mounting ends. A method can include the step of reducing several processing steps needed to create a finished board connector by at least one of at least 10%, at least 20%, at least 30%, at least 33%, at least 40%, at least 50%, at least 60%, at least 70%, at least 80%, at least 90% and at least 95% compared to separately stamping, forming and plating electrical board conductors.

A method to reduce a number of manufacture steps needed to create a multi-material electrical board connector or multi-material cable assembly by at least 30% or at least 31% or at least 32% or at least 33% or at least 34% or at least 35% or at least 36% or at least 37% or at least 38% or at least 38% or at least 39% or at least 40% or at least 41% or at least 42% or at least 43% or at least 44% or at least 45% or at least 46% or at least 47% or at least 48% or at least 49% or at least 50% that includes the step of printing the electrical board connector or the electrical cable assembly during a single print period or print operation or print cycle.

In addition to decreasing the number of manufacturing steps and the total number of undesirable solder joints, an unexpected benefit of the embodiments described herein with respect to FIGS. 1-11 and 14 is that single-ended or differential signal impedance of electrical cable assemblies or waveguides can be tightly controlled over the then entire transmission path or over the entirety of the physical length of an electrical board connector or an electrical cable assembly or over the entire electrical length an electrical board connector or an electrical cable assembly. Due to manufacturing tolerances and varying manufacturing processes, the present invention offers repeatability and signal integrity performance that cannot currently be done by printing or molding or stamping component parts of the electrical cable assembly and then assembling the separate parts. Stated another way, a benefit of 3D printing an entire cable assembly is local and/or tuned and/or tightly controlled impedance control at each point along a waveguide or single-ended or differential signal transmission line.

Any electrical cable assembly 20, 21, 22, 23, 24 described herein can be devoid of any one, any two, any three, any four, or any five of a mechanical crimp between a cable conductor and an associated leadframe conductor; a solder connection between a cable conductor and an associated leadframe conductor; an insulation displacement connection between a cable conductor and an associated leadframe conductor; a weld or ultrasonic weld between a cable connector and an associated leadframe conductor; an electrically conductive polymer or epoxy between a cable connector and an associated leadframe conductor and a laser attach between a cable conductor and an associated leadframe conductor. The cable assembly can be devoid of a mechanically coined or pressed cable conductor.

FIG. 14 illustrates two contacts or electrical conductors 42 of a differential signal pair. Of course, one contact or electrical conductor 42 can be a signal conductor and the remaining contact or electrical conductor 42 can be ground conductor in single-ended application. As shown, twin axial cable conductor 48 of twin axial cable 49 and an associated contact or electrical conductor 42 can form a physically seamless or physically continuous or electrically seamless or physically seamless single or monolithic electrical conductor. Stated another way, an apparatus can include a cable assembly 20, 21, 22, 23, 24 or a cable 30 that is devoid of an attachment transition between the illustrated twinax cable conductor 48 and an associated contact or electrical conductor 42 or between a radio frequency (RF) cable conductor and an associated contact or electrical conductor 42. Stated yet another way, an interconnect, such as a cable assembly 20, 21, 22, 23, 24, can include a contact or electrical conductor 42, such as a signal or single-ended or differential signal conductor, and an associated electrical cable conductor, such as twin axial cable conductor 48 or electrical cable conductor 90 (FIGS. 9 and 10). The electrical cable conductor, such as twin axial cable conductor 48, can be physically attached, electrically attached, or both to the contact or electrical conductor 42, with no visible attachment region or no mechanical attachment between the contact or electrical conductor 42 and the associated shielded cable conductor, such as twin axial cable conductor 48 or electrical cable conductor 90 (FIGS. 9 and 10). Rephrased, a printed circuit board trace or a printed circuit board pad or contact or electrical conductor 42 and a cable conductor, such as a RF cable conductor 47 or the twin axial cable conductor 48 shown, can be monolithic or can be printed as one continuous electrical path one continuous electrical conductor or one continuous electrical transmission line. There can be a seamless physical transition, a seamless electrical transition or both between the twin axial cable conductor 48 and the contact or trace or electrical conductor 42.

Embodiments of the applicant can prevent electrical discontinuities, such as discontinuities that occur when twinax cable conductor 48P (FIG. 13) is soldered to second PCB mount pad 55P (FIG. 13.) Eliminating electrical discontinuities through three-dimensional printing, multiple material printing, or both can improve insertion loss. Elimination of electrical discontinuities can improve impedance matching and can improve impedance tuning to a desired impedance. The present invention permits localized, tuned and/or more precise impedance control over each linear millimeter or over a complete length of a total cable assembly or board connector single-ended or differential signal transmission path, resulting in a precisely tuned and optimized impedance of 100±10Ohms, 100±1Ohms, 100±0.5Ohms, 100±0.1Ohms, 85±5Ohms, 85±1Ohms, 85±0.5Ohms, 85±0.1Ohms, 77±5Ohms, 77±1Ohms, 77+0.5Ohms, 77±0.1Ohms, 75±5Ohms, 75±1Ohms, 75±0.5Ohms, 75±0.1Ohms, 60±5Ohms, 60±1Ohms, 60±0.5Ohms, 60±0.1Ohms, 50±5Ohms, 50±1Ohms, 50±0.5Ohms, 50±0.1Ohms, etc. at each point along an entire physical length, along an electrical length or both of an interconnect, such as an electrical board connector or an electrical cable assembly.

As shown in FIG. 14, skew correction, impedance correction or both can be printed right into a cable assembly or board connector or flex cable or printed circuit board. Air or other electrically dielectric voids 81 can formed around or adjacent to one or more contacts or electrical conductors 42 that form a differential signal pair. Electrical conductors 42 can be printed with jogs 82 designed to equalize skew by leveling electrical lengths of two contacts or electrical conductors of a differential signal pair. Skew correction, impedance correction, or both can be done at the interconnect, at a cable, at a waveguide, and/or at a host PCB level so an entire transmission channel is tuned from one chip or ASIC to another chip or ASIC.

Embodiments described herein can have positive and expected environmental impacts, too. Scrap material can be reduced. Interconnects, such as cable assemblies or board connectors, can be designed in one country and then printed in the same country or even in a different country, negating finished good shipping costs. A method to manufacture an object, such as an interconnect or electrical interconnect, can include a step of creating or a step of opening a model of a multi-material interconnect. Another step can include printing a multi-material interconnect at least 5 km away from where the model was created or from where a print function or print process or a single print period or single print operation. Other steps can include executing a print command and then printing a multi-material interconnect on printer at least 5 km away from where the print command was executed. All that is required at the target print location is a suitable printer, such as a three-dimensional, multi-material printer.

Alternatively, a model that represents an interconnect, such as a cable assembly or a board connector, can be shipped within 5 km of a printer that prints, alone or in combination with another printer, the interconnect from the model. In partial summary, a method to reduce a number of steps needed to create a multi-material electrical cable assembly by at least at least 33% compared to mechanically attached stamped conductors and wires can include a step of printing the multi-material electrical cable assembly 20, 21, 22, 23, 24 as a single piece using a three-dimensional, multi-material printer. A 3D, multi-material, printed cable assembly 22, 23, 24 can include an electrically insulative housing, electrical conductors or contacts or traces or pads carried by the electrically insulative housing and at least one cable electromagnetically and geometrically continuous with a respect a respective one of the electrical conductors or contacts or traces or pads. The impedance of the 3D, multi-material, printed cable assembly 22, 23, 24 can be 100±0.5 Ohms or 85±0.5 Ohms or 75±0.5Ohm or 60±0.5Ohms or 50±0.5 Ohms. A 3D printed cable assembly 22, 23, 24 can include an electrically insulative housing and an electrical conductor or contact or trace or pad carried by the electrically insulative housing. At least one cable can be electromagnetically and geometrically continuous with the electrical conductor or contact or trace or pad without any mechanical attachment between the electrical conductor or contact or trace or pad and the at least one cable. The impedance of the 3D printed cable assembly can be selected from the a group that includes 100±0.5 Ohms or 85±0.5 Ohms or 75±0.5Ohm or 60±0.5Ohms or 50±0.5 Ohms.

A 3D printed, multi-material cable assembly can include an electrically conductive material and an electrically non-conductive material. The electrically conductive material and the electrically non-conductive material are both printed during a single print period or single print cycle or single print operation.

In some embodiments, a method to print an interconnect comprising a step of printing an electrical interconnect that includes electrical conductors and an insulative housing during a single print process or a single print period or single print operation.

In some embodiments, a method to print an interconnect comprising a step of printing a finished electrical interconnect that includes electrical conductors, an insulative housing, and electrical conductor plating during a single print process or a single print period or single print operation.

In some embodiments, an electrical cable assembly comprising an electrically insulative housing. In various embodiments, the assembly may include electrical conductors carried by the electrically insulative housing. In some embodiments, the assembly may include coaxial or twin axial or flex circuit cables each including one or two cable conductors, respectfully, wherein the finished electrical cable assembly is devoid of a mechanically coined or pressed cable conductor; a mechanical crimp between a cable conductor and an associated leadframe conductor or an associated printed circuit board pad; solder connection between a cable conductor and an associated leadframe conductor or an associated printed circuit board pad; an insulation displacement connection between a cable conductor and an associated leadframe conductor or an associated printed circuit board pad; a weld or ultrasonic weld or ultrasonic bond between a cable connector and an associated leadframe conductor or an associated printed circuit board pad; an electrically conductive polymer or an electrically conductive epoxy between a cable connector and an associated leadframe conductor or an associated printed circuit board pad; and a laser attach between a cable conductor and an associated leadframe conductor or an associated printed circuit board pad.

In addition, in some embodiments, the assembly may include noble metal plating carried by one or more of the electrical conductors. In various embodiments, the assembly may include a signal conductor attached to an associated shielded cable conductor, wherein there is no visible attachment region or no mechanical attachment between the signal conductor and the associated cable conductor of a shielded cable.

In some embodiments, a method to reduce a number of steps needed to create a multi-material electrical cable assembly by at least at least 33% compared to mechanically attached stamped conductors and wires comprising a step of printing the multi-material electrical cable as a single piece using a three-dimensional, multi-material printer.

In some embodiments, a 3D printed cable assembly may include an electrically insulative housing. In various embodiments, the assembly may include an electrical conductor or contact or trace or pad carried by the electrically insulative housing. In some embodiments, the assembly may include at least one cable electromagnetically and geometrically continuous with the electrical conductor or contact or trace or pad without any mechanical attachment between the electrical conductor or contact or trace or pad and the at least one cable wherein the impedance of the 3D printed cable assembly is selected from the group comprising: 100±0.5 Ohms or 85±0.5 Ohms or 75±0.5Ohm or 60±0.5Ohms or 50±0.5 Ohms.

In some embodiments, a 3D printed cable assembly may include an electrically conductive material and an electrically non-conductive material, wherein the electrically conductive material and the electrically non-conductive material are both printed during a single print period or single print cycle or single print operation.

In some embodiments, a cable assembly may include an electrically insulative housing. In various embodiments, the assembly may include a plurality of electrical conductors or contacts or traces or pads carried by the electrically insulative housing or a printed circuit board carried by the electrically insulative housing. In some embodiments, the assembly may include a plurality of electrical cable conductors each electrically connected to a corresponding one of the plurality of electrical conductors or contacts or traces or pads, wherein at least 25% of the electrical cable conductors are not mechanically attached to their corresponding electrical conductor or contact or trace or pad.

In addition, in some embodiments, wherein at least 50% of the electrical cable conductors are not mechanically attached to a corresponding electrical conductor or contact or trace or pad. In various embodiments, wherein at least 75% of the electrical cable conductors are not mechanically attached to a corresponding electrical conductor or contact or trace or pad. In some embodiments, wherein 100% of the electrical cable conductors are not mechanically attached to a corresponding electrical conductor or contact or trace or pad. In various embodiments, the method or cable assembly or waveguide according may include an electrically lossy material, a magnetic absorbing material, or both.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,”“holding,”“composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being conducted in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled,” and variations thereof are not restricted to physical or mechanical connections or couplings.

The foregoing description of several embodiments of the invention has been presented for purposes of illustration. It is not intended to be exhaustive or to limit the invention to the precise steps and/or forms disclosed, and obviously many modifications and variations are possible in light of the above teaching.

1. A cable assembly comprising:
a cable and at least one first connector monolithically attached to a first end of the cable; and
wherein the cable and the at least one first connector are both printed using a 3D printer.

2. The cable assembly of claim 1 further comprising at least one second connector monolithically attached to a second end of the cable, wherein the second end of the cable is opposite the first end of the cable.

3. The cable assembly of claim 1 wherein the cable is a hollow waveguide.

4. The cable assembly of claim 1 wherein the cable comprises at least one electrical cable conductor.

5. The cable assembly of claim 1 wherein the cable comprises at least two electrical cable conductors.

6. The cable assembly of claim 1 wherein the at least one first connector comprises a first vacuum port.

7. The cable assembly of claim 2 wherein the at least one second connector comprises a second vacuum port.

8. The cable assembly of claim 1 wherein the cable is not extruded.

9. The cable assembly of claim 1 wherein the at least one first connector comprises no stamped electrical connector conductors.

10. The cable assembly of claim 1 wherein the cable assembly is printed within an area of approximately 50 mm cubed.

11.-49. (canceled)

50. A 3D printed electrical connector comprising:
a 3D printed electrically non-conductive housing; and
at least one 3D printed electrical contact or electrical conductor.

51.-53. (canceled)

54. An electrical cable assembly comprising:
an electrically insulative housing;
electrical conductors carried by the electrically insulative housing; and
coaxial or twin axial or flex circuit cables each including one or two cable conductors, respectfully,
wherein the finished electrical cable assembly is devoid of a mechanically coined or pressed cable conductor; a mechanical crimp between a cable conductor and an associated leadframe conductor or an associated printed circuit board pad; solder connection between a cable conductor and an associated leadframe conductor or an associated printed circuit board pad; an insulation displacement connection between a cable conductor and an associated leadframe conductor or an associated printed circuit board pad; a weld or ultrasonic weld or ultrasonic bond between a cable connector and an associated leadframe conductor or an associated printed circuit board pad; an electrically conductive polymer or an electrically conductive epoxy between a cable connector and an associated leadframe conductor or an associated printed circuit board pad; and a laser attach between a cable conductor and an associated leadframe conductor or an associated printed circuit board pad.

55. The electrical cable assembly of claim 54 further comprising noble metal plating carried by one or more of the electrical conductors.

56.-58. (canceled)

59. A 3D printed cable assembly comprising:
an electrically conductive material and an electrically non-conductive material; and
wherein the electrically conductive material and the electrically non-conductive material are both printed during a single print period or single print cycle or single print operation.

60.-64. (canceled)
